(19) United States
(12) Patent Application Publication
(10) Pub. No.: US 2005/0231892 A1
(43) Pub. Date: Oct. 20, 2005

(54) High energy density electric double-layer capacitor and method for producing the same

(76) Inventor: Troy A. Harvey, Salt Lake City, UT (US)

Correspondence Address: Troy A. Harvey, 7875 Da Vinci Dr., Salt Lake City, UT, 84121, US

(21) Appl. No.: 11/109,154

(22) Filed: Apr. 19, 2005

Related U.S. Application Data
(60) Provisional application No. 60/563,312, filed on Apr. 19, 2004.

(51) Int. Cl. H01G 9/00

(52) U.S. Cl. 361/502

(57) ABSTRACT

An electric double layer capacitor includes polarizable electrodes immersed in an organic electrolyte, wherein the electrodes are self-binding and the electric double layer capacitor exhibits a high energy density.

### CROSS REFERENCE TO RELATED APPLICATIONS

This application claims the benefit of U.S. Provisional Patent Application No. 60/563,312 entitled “High energy density electric double layer capacitor and method for producing the same” and filed on Apr. 19, 2004 for Troy Aaron Harvey.

### BACKGROUND OF THE INVENTION

1. Field of the Invention

The present invention relates to an electric double layer capacitor comprised of polarizable electrodes immersed in an organic electrolyte, and a method for constructing the same.

2. Discussion of Prior Art

Double-layer capacitors have theoretical limits for specific capacitance and energy density that are superior to conventional capacitors. Despite this, double-layer capacitors continue to exhibit low volumetric energy densities as compared to conventional electrochemical batteries.

Typical double layer capacitors use activated carbons having a high surface area in the electrodes. In these carbons, surface areas typically range from 1500-3000 square meter per gram of carbon. Activated carbons, however, have two major drawbacks. First, while surface area is relatively controllable during the activation process, the pore sizes and volumes are not. Consequently, much of the surface area available has been difficult to realize due to the fact that the many of the pore spaces are too small to accommodate to ions. Achievable capacities using these materials typically range between 5-15 F/cc raw electrode volume in organic electrolytes. The second major problem is the catalytic nature of the carbon surface area due to reactive functional groups that form during the activation process. This limits the potential window of the cell to 2.5-2.7 volts per cell, much lower than the 4-4.5 volts per cell theoretically achievable by the electrolytes themselves.

A novel form of graphitic carbon has shown promise in overcoming the limitations of activated carbon. To form the graphitic carbon, a carbon bearing precursor is pyrolyzed to form a graphitic or semi-graphitic carbon, and then mixed with a potassium or sodium compound. When heated to a high temperature, the potassium or sodium ions intercalate between the graphitic platelets. The graphitic platelets are left with an increased inter-platelet spacing, which allows ion accumulation when charging assembled capacitors.

The benefits of the method are two fold. One, the graphite is “activated” on first charging by the electrolyte ions themselves—creating a pore size just large enough to accept the ions, thus creating the possibility of increased volumetric capacities. Second, the surface of the pores is highly graphitic, with the majority of bonds dedicated to carbon-carbon bonding without significant functionalities on the surface. This increases the potential window of the capacitor cell, allowing the use of voltages above 3.5 volts.

However, alkali graphitic carbons suffer from an expansion problem. Upon first charging, the ions force their way between the graphite platelets, causing the electrodes to significantly expand and lose most of the increased volumetric capacity.

### SUMMARY OF THE INVENTION

The present invention has been developed in response to the present state of the art, and in particular, in response to the problems and needs in the art that have not yet been fully solved by currently available capacitors based on alkali graphitic carbons. Accordingly, the present invention has been developed to provide capacitors based on graphitic carbons that achieve high volumetric capacities by reducing graphitic expansion upon charging.

The apparatus, in one embodiment, is configured to enable graphitic carbon used in electrodes of electric double layer capacitors to achieve high energy densities. The apparatus includes an electric double-layer capacitor that has at least two polarizable electrodes immersable in an organic electrolyte. The electrodes may be made of a carbonaceous material formed from a carbon bearing precursor that is heat treated in a substantially anoxic environment, thereby driving off volatile content and increasing the graphitic regions within the carbon. In addition, the carbonaceous material may be bound together to form an electrode pre-form geometry, and the electrode pre-form may be mixed with an alkali containing compound and heat treated in a substantially anoxic environment.

### BRIEF DESCRIPTION OF THE DRAWINGS

FIG. 1 is a cross-sectional view illustrating an arrangement of a high energy-density double-layer capacitor according to one embodiment of the current invention;

FIGS. 2A-2D are perspective views illustrating the production steps of a process of making a series connected stack of high energy-density electric double-layer capacitors according to one embodiment of the current invention using polymer pouch packaging arranged into a single capacitor high-voltage module;

FIGS. 3A-3C are perspective views illustrating the production steps of a process of making a series connected bipolar stack of high energy-density electric double layer capacitors according to one embodiment of the current invention arranged into a single capacitor high-voltage module; and

FIG. 4 is a perspective view illustrating a wound cylinder type packaging of a high energy-density electric double-layer capacitor according to one embodiment of the current invention.

### DESCRIPTION OF THE PREFERRED EMBODIMENTS

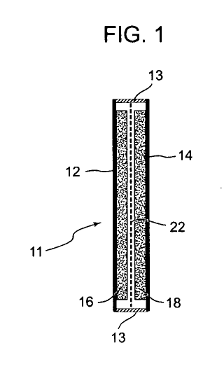

Explanation will be made below with reference to FIGS. 1-4 for illustrative embodiments concerning the high energy-density electric double-layer capacitor and the method for producing the same according to the present invention.

In its fundamental form, the high energy-density double-layer capacitor according to the present invention includes, for example, the type of unit cell 11 as shown in the cross-sectional view in FIG. 1. The unit cell 11 comprises a positive polarizable electrode 16 and a negative polarizable electrode 18, which are formed on or conductively attached to two collectors 12 and 14. The two collectors 12 and 14 provide a conduction path out of the cell. The unit cell 11 further comprises an optional separator 22 which is interposed between the polarizable electrodes 16 and 18 to provide electrical isolation between the electrodes while allowing electrolyte conductivity. The separator 22 may be comprised of a porous polymer, cellulose, paper, glass matt, or non-porous ion conducting membrane. In the depicted embodiment, aluminum or conductive polymers, as blended with a carbon material, are used for the collectors 12, 14, and unit cell 11 is immersed or filled with an organic electrolyte and then sealed with end caps 13 in order to contain the electrolyte.

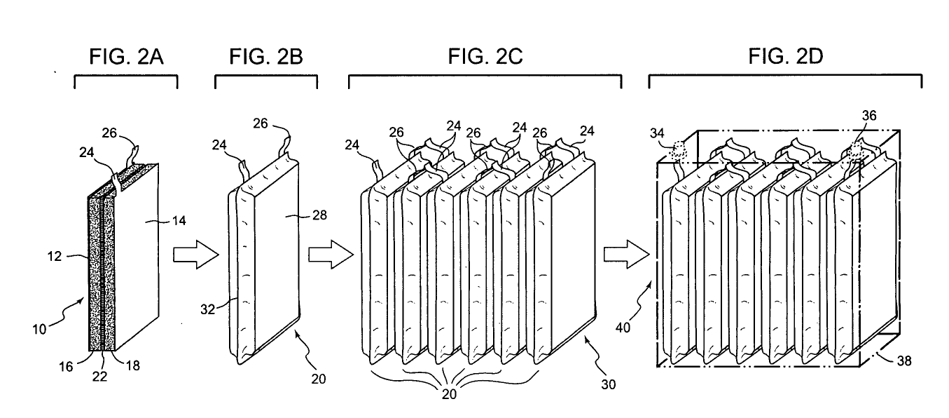

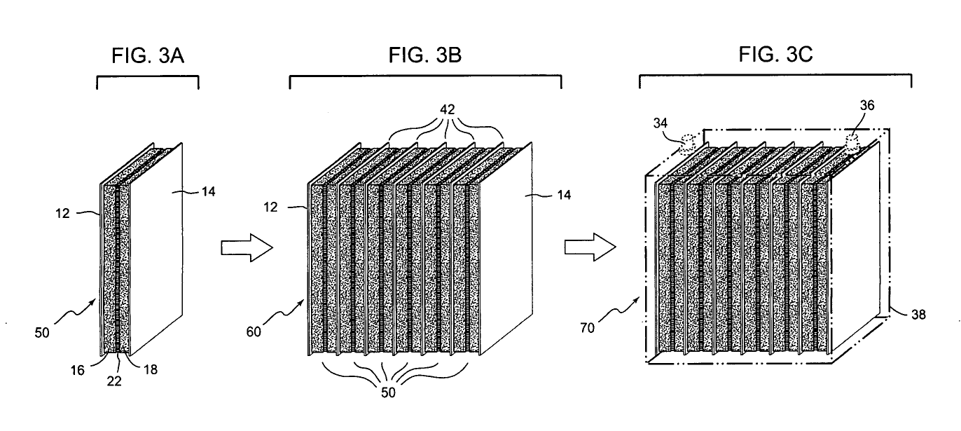

Multiple unit cells may also be connected in series or parallel electrical arrangements (or combinations thereof) in a single package in order to provide a higher voltage stack, as depicted in FIGS. 2A to 2D and FIGS. 3A to 3C.

In one such embodiment, a type of capacitor module 40, shown in FIG. 2D, is constructed using a multiplicity of unit cells 10. As depicted, each of the unit cells 10 in FIG. 2A includes a positive polarizable electrode 16 and a negative polarizable electrode 18, which are formed on or conductively attached to two collectors 12 and 14. Electrical leads 24 and 26 enable conduction of electricity out of the cell 10. The unit cell 10 may include an optional separator 22 interposed between the polarizable electrodes 16 and 18 to provide electrical isolation between the electrodes while allowing electrolyte conductivity.

As shown in FIG. 2B, the unit cell 10 may subsequently be sealed in a polymer, foil or foil-polymer package 28 and filled with an organic electrolyte. The edges 32 may be sealed, forming an enclosed unit cell 20 having electrical leads 24, 26 emerging from the package.

A multiplicity of packaged unit cells 20 may be assembled in a stack, such as the series assembly shown in FIG. 2C, wherein the cell leads 24, 26 are alternatively connected in series, positive to negative. The depicted cells 20 are enclosed in an optionally air-tight container 38, shown in FIG. 2D, to form a singular packaged unit 40 having positive and negative terminals 34, 36, which are electrically attached to the end leads of the multi-cell stack.

In another embodiment, a type of bipolar capacitor module 70, illustrated in FIG. 3C, may be constructed using a multiplicity of unit cells 50, where each of the unit cells 50, shown in FIG. 3A, includes a positive polarizable electrode 16 and a negative polarizable electrode 18 formed on or conductively attached to two collectors 12 and 14. The unit cell 50 further includes an optional separator 22 interposed between the polarizable electrodes 16 and 18 to provide electrical isolation between the electrodes while allowing electrolyte conductivity. In the depicted embodiment, aluminum or conductive polymers may be used for the collectors 12, 14 respectively, and a carbon material formed according to one embodiment of the present invention

As shown in FIG. 3B, a multiplicity of unit cells 50 are stacked in a bipolar arrangement 60, such that each positively polarized electrode shares an electrical collector 42 with the negatively polarized electrode of the adjacent cell. In order to conduct electricity through the full face of the collector, each cell in turn may be stacked accordingly until the end cells terminate in the end collectors 12 and 14.

The assembled stack 60 may be immersed in an organic electrolyte and sealed in an enclosed air-tight container 38, shown in FIG. 3C, to form a singular packaged unit 70 having positive and negative terminals 34, 36 which are electrically attached to the end collectors of the multi-cell stack.

Both types of flat plate capacitors 40, 70 are characterized such that a high degree of charge can be affected, a large size can be obtained, and the volumetric energy density of such arrangements is high, most especially in the bipolar arrangement 70.

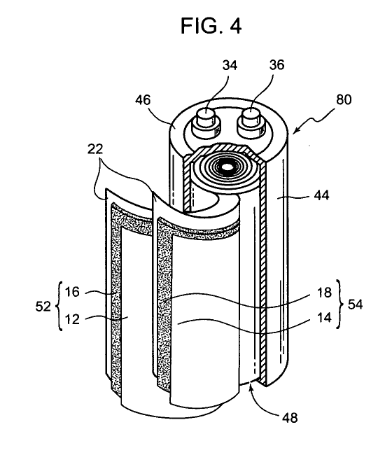

In addition to the flat type high energy-density electric double-layer capacitors described above, a wound type capacitor 80 is also possible as shown in FIG. 4. The high energy-density double-layer capacitor 80 may include a wound core 48 composed of a positive electrode sheet 52 that includes a positive polarizable electrode 16 formed on or conductively attached to a collector 12 and a negative electrode sheet 54 wound to have a cylindrical configuration with a separator 22 interposed there between.

The wound core 48 may be accommodated, for example, in a cylindrical aluminum or polymer-foil case 44, which may be filled with an organic electrolyte (not shown). The case 44 may be sealed with a top plate 46 through which terminals 34, 36 carry the electricity from the aforementioned collectors 12, 14.

The carbon material used for the electric double layer capacitor electrodes 16, 18 may be comprised of alkali activated graphitic or semi-graphitic carbon formed into various geometries, such as sheets, blocks, or shapes according to one embodiment of the present invention.

In one embodiment, the alkali activated carbon may be made from carbon-bearing precursors and further heat processed in a predominantly anoxic environment to create graphitic regions within the carbon. The carbon-bearing precursors may be selected from a substance of coal, oil, or petroleum origin, such as coal, coke, petroleum pitch, petroleum coke, lignite, high molecular weight oils or waxes, or asphaltenes. Alternatively, the carbon-bearing precursors may be of herbaceous origin—such as wood, bamboo, coconut husks, nut shells, peat, fruit pits (e.g. olive, cherry, plum, etc.), corn stalks, and grain husks. The precursor may be pyrolyzed, if required, and further heat treated to increase the graphitic content. The temperature of the heat treatment depends on the precursor. Precursors having a higher graphitic content or higher structured carbon content, such as coals, coke, petroleum coke, or petroleum pitch may be heated to a temperature of about 750° C.-1200° C., preferably 800° C.-1000° C. Less structured carbons, such as many produced from herbaceous origin, must be graphitized at a higher temperature, typically about 1200° C.-1900° C.

After heat treatment the graphitized carbon may be ground to reduce particle size, if required, and bound with a carbon-bearing substance or adhesive and pyrolyzed again to form a graphite-carbon composite electrode. One such binder choice is thermoset resins, such as phenolic, furfurals, and epoxides. The preferred ratio of binder to carbon is about 15:85 to 40:60 respectively. The mixture of the resin and graphitic carbon may be processed using heat and formed, pressed, molded, cast, extruded, or rolled into sheets, blocks or shapes. Upon pyrolyzation, the thermoset binder is preferably converted to a carbonaceous remnant having an amorphous or glassy carbon structure. The composite electrode subsequently may be mixed with an alkali compound and further heat processed to a temperature at which the alkali substantially vaporizes.

As a result, the graphitic carbon may be intercalated with the alkali metal while substantially preserving the amorphous or glassy carbon binder portion. A preferred temperature of alkali activation is about 700-1100° C. Further, the pyrolyzation of the binder and the alkali activation steps may be combined in one heat processing step. After the alkali activation step, the electrodes may be further washed in water to remove the excess alkali metal, and then dried to prepare the electrodes for integration into a capacitor.

In another embodiment, the binder may be a thermoplastic polymer such as methyl cellulose or polyvinylidene difluoride, ground into a fine powder or plasticized in a solvent, or used in the form of a dispersion. The polymer may be mixed with the graphitic or semi-graphitic carbon and formed, pressed, molded, cast, extruded, or rolled into various geometries. Heat and pressure may be used to mold the electrode pre-forms. The pre-forms may be pyrolyzed in an anoxic environment at a slow temperature rate increase, for example, 50° C. per hour. Upon pyrolyzation, the polymer binder is preferably converted to a carbonaceous remnant having an amorphous carbon structure. The composite electrode may subsequently be mixed with an alkali compound and further heat processed to a temperature at which the alkali substantially vaporizes. As discussed, the graphitic carbon may be intercalated with alkali metal without substantially changing the amorphous carbon binder portion. A preferred temperature of alkali activation is about 700-1100° C. Further, the pyrolyzation of the binder and the alkali activation steps may be combined in one heat processing step. After the alkali activation step, the electrodes may be further washed in water to remove the excess alkali metal, and then dried to prepare them for integration into a capacitor.

In another embodiment, the binder may be carbon-bearing substance emulsions, or adhesives such as, lignins, celluloses, hemicellulose, starches, and proteins, ground into a fine powder or used in the form of a dispersion or emulsion. The carbon-bearing substance may be mixed with the graphitic or semi-graphitic carbon and formed, pressed, molded, cast, extruded, or rolled into electrode pre-form geometry. Heat, pressure and chemical activators may be used to mold the electrode pre-forms. The pre-forms may subsequently be pyrolyzed in a substantially anoxic environment at a temperature rate increase with regard to the binder material choice. Upon pyrolyzation, the binder is preferably converted to a carbonaceous remnant having an amorphous carbon structure as described above. A preferred temperature of alkali activation is about 700-1100° C. Further, the pyrolyzation of the binder and the alkali activation steps may be combined in one heat processing step. After the alkali activation step, the electrodes may be further washed in water to remove the excess alkali metal, and then dried to prepare them for integration into a capacitor.

In another embodiment, the binder may be a carbon-bearing substance or emulsion of heavy oils, pitches, tars, bitumens, waxes, and asphaltenes. The above carbon bearing substances may be of coal or petroleum origin, or herbaceous, woody, or agricultural origin or synthetically derived thereof. The carbon-bearing substance may be mixed with the graphitic carbon forming a paste or emulsion. Surfactants and stabilizers may be used into improve the dispersion of the graphitic carbon. Water or low weight oils may also be added to the emulsion as processing aids or pore formers. The paste or emulsion may be formed, pressed, molded, cast, extruded, or rolled into sheets, blocks, shapes or the like. Heat, pressure and chemical activators may be used aid in processing the electrode pre-forms. The pre-forms may be pyrolyzed in a substantially anoxic environment at a temperature rate increase with regard to the binder material choice. A preferred temperature of alkali activation is about 700-1100° C. The pyrolyzation of the binder and the alkali activation steps may be combined in one heat processing step. After the alkali activation step, the electrodes may be further washed in water to remove the excess alkali metal, and then dried to prepare them for integration into a capacitor.

In another embodiment, the electrode pre-form may have no secondary binder but is manufactured in one step using a carbon-bearing substance or emulsion of heavy oils, tars, pitches, bitumens, waxes, and asphaltenes without adding a secondary graphitic carbon powder. The above carbon bearing substances may be of coal or petroleum origin, or herbaceous, woody, or agricultural origin or synthetically derived thereof. The carbon-bearing substances may be of a bituminous quality already suspending a large solid content, or having large content of high molecular weight oils, tars, pitches, waxes, or asphaltenes which are easily converted into a porous graphitic electrode.

Alternatively, carbon-bearing substances may be mixed into emulsions having regions of high carbon yield substances suspended in lower carbon yield substances. Surfactants and stabilizers may be used to improve the dispersion of high carbon yield substances. Water or low weight oils may also be added to the emulsion as processing aids or pore formers. The paste or emulsion may be formed, pressed, molded, cast, extruded, or rolled into sheets, blocks, shapes, or the like. Heat, pressure and chemical activators may be used to aid in processing the electrode pre-forms. The pre-forms may be pyrolyzed in a substantially anoxic environment at a temperature rate increase with regard to the material choice and a final temperature sufficient to create graphitic regions in the carbon. Upon pyrolyzation the electrode pre-form preferably forms a solid electrode having a substantially graphitic carbon structure with amorphous regions having sufficient porosity to provide pathways for the electrolyte in the final capacitor. A preferred temperature range is about 800° C.-1700° C., depending on precursor choices. The composite electrode may be mixed with an alkali compound and further heat processed to a temperature at which the alkali substantially vaporizes. The result leaves the graphitic carbon intercalated with said alkali metal, while not substantially changing the amorphous carbon binder portion. A preferred temperature of alkali activation is about 700° C.-1100° C. Further, the pyrolyzation of the pre-form and the alkali activation steps may be combined in one heat processing step. After the alkali activation step, the electrodes may be further washed in water to remove the excess alkali metal, and then dried to prepare them for integration into a capacitor.

The alkali compound of the above embodiments may be a sodium or potassium compound or sodium or potassium metal. Compounds of potassium or sodium may include hydroxides, carbonates, acetates, benzoates, butyrates, formates, or peroxides, or combinations thereof. A preferred alkali is potassium hydroxide or sodium hydroxide, because those compounds may be easily recycled in the washing step after alkali activation.

The electrodes may additionally contain carbon bearing fibers to improve the bound electrode strength. Examples of such fibers include phenolic, pitch, cellulose, lignins, rayon, or carbon. The electrodes may additionally contain pore forming agents such as acrylic polymers, polypropylene carbonate, and polyethylene carbonate.

The electrostatic capacity of the electrode is expressed in farads, as developed between the solute ions of the organic electrolyte and the carbon of the electrode, whether the ions forming the electrostatic storage field are adjacent to the carbon surface, diffused, absorbed on the carbon surface, or through insertion between carbon layers.

In one embodiment, the solute of the organic electrolyte includes, but is not limited to, one of the following anions: tetrafluoroborate (BF₄—), hexafluorophosphate (PF₆—), hexafluoroarsenate (AF₆—), perchlorate (ClO₄—), CF₃SO₃—, (CF₃SO₂)₂N—, C₄F₉SO₃—. The solute of the organic electrolyte may include, but is not limited to, the following cations:

One cation may be represented by the following formula:

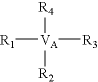

Wherein the central atom V_{A} is one of the periodic table group VA elements (N, P, As . . . ) and where the four radicals R₁, R₂, R₃, R₄ may individually support one of the following groups: methyl, ethyl, propyl, butyl, or pentyl. Examples include tetraethylammonium (Et₄N+) and 1-methyl-3-ethylphosponium (Et₃MeP+). Alternatively, any two of the radical attachment points may support a cyclic hydrocarbon, examples include dialkylpyrrolidinium or dialkylpiperidinium.

Another cation may be represented by the following formula.

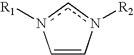

Wherein R₁ and R₂ are alkyl groups each having from 1 to 5 carbon atoms, R₁ and R₂ may be the same group or different groups. An example of which is 1-ethyl-3-methylimidazolium.

The solvent of the organic electrolyte may be a dipolar aprotic solvent. Examples include, but are not limited to: propylene carbonate (PC), butylene carbonate (BC), ethylene carbonate (EC), gamma-butyrolactone (GBL), gamma-valerolactone (GVL), glutaronitrile (GLN), adipnitrile (ADN), acetonitrile (AN), sulfolane (SL), trimethyl phosphate (TMP), dimethyl carbonate (DMC), ethyl methyl carbonate (EMC), or diethyl carbonate (DEC).

A solvent comprised of a mixture composed of a primary solvent containing at least one aprotic solvent, such as those mentioned above, and a secondary solvent containing either another of a dipolar aprotic solvents, or another non-polar organic co-solvent may also be used.

With the use of ionic liquids, such as the aforementioned imidazolium cation containing ionic liquids, the electrolyte may contain only a neat ionic liquid, and no other solvent. Alternatively, the ionic liquid co-solves another solute of cations and anions.

### EXAMPLE 1

Petroleum coke is ground to a fine powder and then pyrolyzed in an anoxic furnace at 900° C. for 3 hours to remove volatile content and increase the graphitic regions in the carbon. The resulting graphitic carbon is then ground to fine powder again. The graphitic powder is mixed with a low melt flow phenol-hexamethylene tetramine resin (Plenco) powder with a mass ratio of 70:30 respectively. The resulting mix is pressed in a hydraulic die at 600 PSI pressure at 150° C. forming a solid self-bound electrode pre-form. This composite electrode is then mixed with a sodium hydroxide in a 1:1 mass ratio and “activated” by heating in an anoxic furnace at 850° C. The result leaves the graphitic carbon intercalated with alkali metal, while not substantially changing the amorphous or glassy carbon portion formed by the phenolic binder. The electrodes are then further washed in water to remove the excess alkali metal, and then dried to prepare them for integration into a capacitor. The wash water is concentrated and then spray dried to form solid potassium hydroxide to be recycled in the next batch.

Two such electrodes are bonded to aluminum collectors, a microporous polypropylene separator interposed between them, then placed in a polymer foil pouch. The pouch is vacuum filled with 2.7 molar 1-methyl-3-ethylammonium tetrafluoroborate in propylene carbonate, and sealed leaving two aluminum tabs, one connected to each electrode, exposed through the seal. The capacitor is then cycled 1 time to complete the “electrochemical activation” of the electrodes while being held in an ridged container measuring 110% the width of the thinnest face of the electrodes.

### EXAMPLE 2

Coconut shell is ground to a fine powder and then pyrolyzed in an anoxic furnace at 1700° C. for 2 hours to remove volatile content and increase the graphitic regions in the carbon. The resulting graphitic carbon is then ground into a fine powder again. The graphitic powder is mixed with a cellulose powder having a mass ratio of 80:20 respectively. Water is added to the resulting mix and pressed in a hydraulic die at 600 PSI pressure at 208° C. for 3 minutes, creating steam, converting some of the cellulose to furfurals and crosslinking, and forming a solid self-bound electrode pre-form. This composite electrode is then mixed with potassium hydroxide in a 1:2 mass ratio and “activated” by heating in an anoxic furnace at 900° C. The result leaves the graphitic carbon intercalated with the alkali metal. The electrodes are then further washed in water to remove the excess alkali metal, and then dried to prepare them for integration into a capacitor.

Two such electrodes are bonded to aluminum collectors, with a microporous polypropylene separator interposed between them, and placed in a polymer foil pouch. The pouch is vacuum filled with 2.7 molar 1-methyl-3-ethylammonium tetrafluoroborate in propylene carbonate, and sealed leaving two aluminum tabs, one connected to each electrode, exposed through the seal. The capacitor is then cycled 5 times to complete the “electrochemical activation” of the electrodes.

### EXAMPLE 3

Cellulose is ground to a fine powder and water added to moisten the cellulose. The cellulose mixture is pressed in a hydraulic die at 300 PSI pressure at 208° C. for 3 minutes, creating steam and converting some of the cellulose to furfurals, polymerizing and crosslinking the cellulose, which forms a solid porous self-bound electrode pre-form. The electrode pre-form is then pyrolyzed in an anoxic furnace at 1700° C. for 2 hours to remove volatile content and increase the graphitic regions in the carbon. This electrode is then mixed with potassium hydroxide in a 1:1 mass ratio and “activated” by heating in an anoxic furnace at 900° C. The result leaves the graphitic carbon intercalated with the alkali metal. The electrodes are then further washed in water to remove the excess alkali metal, and then dried to prepare them for integration into a capacitor.

Two such electrodes are bonded to aluminum collectors, and with a microporous polypropylene separator interposed between them, placed in a polymer foil pouch. The pouch is vacuum-filled with 2.7 molar 1-methyl-3-ethylammonium tetrafluoroborate in propylene carbonate, and sealed leaving two aluminum tabs, one connected to each electrode, exposed through the seal. The capacitor is then cycled 5 times to complete the “electrochemical activation” of the electrodes.

### EXAMPLE 4

Hemicellulose and lignin are mixed together and ground to a fine powder. Water is added to moisten the mixture. The mixture is then pressed in a hydraulic die at 200 PSI pressure at 208° C. for 3 minutes, creating steam and converting some of the cellulose to furfurals, polymerizing and crosslinking the mixture, forming a solid porous self-bound electrode pre-form. The electrode pre-form is then pyrolyzed in an anoxic furnace at 1700° C. for 2 hours to remove volatile content and increase the graphitic regions in the carbon. This electrode is then mixed with potassium hydroxide in a 1:1 mass ratio and “activated” by heating in an anoxic furnace at 900° C. The result leaves the graphitic carbon intercalated with the alkali metal. The electrodes are then further washed in water to remove the excess alkali metal, and then dried to prepare them for integration into a capacitor.

Two such electrodes are bonded to aluminum collectors, and with a microporous polypropylene separator interposed between them, placed in a polymer foil pouch. The pouch is vacuum-filled with 2.7 molar 1-methyl-3-ethylammonium tetrafluoroborate in propylene carbonate, and sealed leaving two aluminum tabs, one connected to each electrode, exposed through the seal. The capacitor is then cycled 5 times to complete the “electrochemical activation” of the electrodes.

### EXAMPLE 5

Finely powdered sucrose is mixed with water to moisten the mixture. The mixture is then pressed in a hydraulic die at 100 PSI pressure at 120° C. for 3 minutes, forming a solid porous self-bound electrode pre-form. The electrode pre-form is then pyrolyzed in an anoxic furnace at 1700° C. for 3 hours to remove volatile content and increase the graphitic regions in the carbon. This electrode is then mixed with potassium hydroxide in a 1:1 ratio and “activated” by heating in an anoxic furnace at 900° C. The result leaves the graphitic carbon intercalated with the alkali metal. The electrodes are then further washed in water to remove the excess alkali metal, and then dried to prepare them for integration into a capacitor.

Two such electrodes are bonded to aluminum collectors, and with a microporous polypropylene separator interposed between them, and placed in a polymer foil pouch. The pouch is vacuum-filled with 2.7 molar 1-methyl-3-ethylammonium tetrafluoroborate in propylene carbonate, and sealed leaving two aluminum tabs, one connected to each electrode, exposed through the seal. The capacitor is then cycled 5 times to complete the “electrochemical activation” of the electrodes.

### EXAMPLE 6

Finely powdered sucrose is mixed with water to moisten the mixture. The mixture is then pressed in a hydraulic die at 100 PSI pressure at 120° C. for 3 minutes, forming a solid porous self-bound electrode pre-form. The electrode pre-form is then pyrolyzed in an anoxic furnace at 1700° C. for 3 hours to remove volatile content and increase the graphitic regions in the carbon. This electrode is then mixed with potassium hydroxide in a 1:1 ratio and “activated” by heating in an anoxic furnace at 900° C. The result leaves the graphitic carbon intercalated with the alkali metal. The electrodes are then further washed in water to remove the excess alkali metal, and then dried to prepare them for integration into a capacitor.

Two such electrodes are bonded to aluminum collectors, and with a microporous polypropylene separator interposed between them, and placed in a polymer foil pouch. The pouch is vacuum-filled with 2.7 molar 1-methyl-3-ethylammonium tetrafluoroborate in propylene carbonate, and sealed leaving two aluminum tabs, one connected to each electrode, exposed through the seal. The capacitor is then cycled 5 times to complete the “electrochemical activation” of the electrodes.

### EXAMPLE 7

Coal coke is ground to a fine powder and then pyrolyzed in an anoxic furnace at 900° C. for 3 hours to remove volatile content and increase the graphitic regions in the carbon. The resulting graphitic carbon is then ground to fine powder again. The graphitic powder is mixed with a petroleum tar in a 80:20 ratio and extruded into a sheet. The resulting pre-form sheet is then pyrolyzed in an anoxic furnace at 900° C. for 3 hours to remove volatile content, bind the graphic carbon together, and increase the graphitic regions in the binder. This composite electrode is then mixed with a sodium hydroxide in a 1:1 mass ratio and “activated” by heating in an anoxic furnace at 850° C. The result leaves the graphitic carbon intercalated with the alkali metal. The electrodes are then further washed in water to remove the excess alkali metal, and then dried to prepare them for integration into a capacitor.

Two such electrodes are bonded to aluminum collectors, and with a microporous polypropylene separator interposed between them, and placed in a polymer foil pouch. The pouch is vacuum-filled with 2.7 molar 1-methyl-3-ethylammonium tetrafluoroborate in propylene carbonate, and sealed leaving two aluminum tabs, one connected to each electrode, exposed through the seal. The capacitor is then cycled 5 times to complete the “electrochemical activation” of the electrodes.

### EXAMPLE 8

Petroleum bitumen, having a high carbon yield, is cast into an electrode-shaped mold. The resulting pre-form mold is placed in a furnace and pyrolyzed in an anoxic furnace at 1000° C. for 3 hours to remove volatile content, creating a porous solid bound electrode with high level of graphitic regions in the char. This electrode is then mixed with a sodium hydroxide in a 1:1 mass ratio and “activated” by heating in an anoxic furnace at 850° C. The result leaves the graphitic carbon intercalated with the alkali metal. The electrodes are then further washed in water to remove the excess alkali metal, and then dried to prepare them for integration into a capacitor.

Two such electrodes are bonded to aluminum collectors, and with a microporous polypropylene separator interposed between them, and placed in a polymer foil pouch. The pouch is vacuum-filled with 2.7 molar 1-methyl-3-ethylammonium tetrafluoroborate in propylene carbonate, and sealed leaving two aluminum tabs, one connected to each electrode, exposed through the seal. The capacitor is then cycled 5 times to complete the “electrochemical activation” of the electrodes.

### EXAMPLE 9

High molecular weight oil is mixed with water and surfactant in a high speed blender forming an emulsion having fine water droplets. The oil is then thoroughly mixed with petroleum pitch having a high carbon yield, and cast into an electrode shaped mold. The resulting pre-form mold is placed in a furnace and pyrolyzed in an anoxic furnace at 1000° C. for 3 hours to remove volatile content, creating a porous solid bound electrode with high level of graphitic regions in the char. This electrode is then mixed with an sodium hydroxide in a 1:1 mass ratio and “activated” by heating in an anoxic furnace at 850° C. The result leaves the graphitic carbon intercalated with the alkali metal. The electrodes are then further washed in water to remove the excess alkali metal, and then dried to prepare them for integration into a capacitor.

Two such electrodes are bonded to aluminum collectors, and with a microporous polypropylene separator interposed between them, and placed in a polymer foil pouch. The pouch is vacuum-filled with 2.7 molar 1-methyl-3-ethylammonium tetrafluoroborate in propylene carbonate, and sealed leaving two aluminum tabs, one connected to each electrode, exposed through the seal. The capacitor is then cycled 5 times to complete the “electrochemical activation” of the electrodes.

### EXAMPLE 10

Coal coke is ground to a fine powder and then pyrolyzed in an anoxic furnace at 900° C. for 3 hours to remove volatile content and increase the graphitic regions in the carbon. The resulting graphitic carbon is then ground to fine powder again. The graphitic powder is mixed with corn starch in a 70:30 ratio with water and briquetted into an electrode pre-form. The resulting pre-form sheet is then pyrolyzed in an anoxic furnace at 900° C. for 3 hours to remove volatile content, pyrolyze the starch, bind the graphic carbon together, and increase the graphitic regions in the binder. This composite electrode is then mixed with a sodium hydroxide in a 1:1 mass ratio and “activated” by heating in an anoxic furnace at 900° C. The result leaves the graphitic carbon intercalated with the alkali metal. The electrodes are then further washed in water to remove the excess alkali metal, and then dried to prepare them for integration into a capacitor.

Two such electrodes are bonded to aluminum collectors, and with a microporous polypropylene separator interposed between them, and placed in a polymer foil pouch. The pouch is vacuum-filled with 2.7 molar 1-methyl-3-ethylammonium tetrafluoroborate in propylene carbonate, and sealed leaving two aluminum tabs, one connected to each electrode, exposed through the seal. The capacitor is then cycled 5 times to complete the “electrochemical activation” of the electrodes.

### EXAMPLE 11

Coal coke is ground to a fine powder and then pyrolyzed in an anoxic furnace at 900° C. for 3 hours to remove volatile content and increase the graphitic regions in the carbon. The resulting graphitic carbon is then ground to fine powder again. The graphitic powder is mixed with polyvinylidene difluoride powder in a 70:30 ratio, and heat pressed at 270° C. into an electrode pre-form. The resulting pre-form sheet is then pyrolyzed in an anoxic furnace at a heat rate increase of 50° C. per hour to 900° C. and held for 3 hours to pyrolyze the binder. This composite electrode is then mixed with a sodium hydroxide in a 1:1 mass ratio and “activated” by heating in an anoxic furnace at 900° C. The result leaves the graphitic carbon intercalated with the alkali metal. The electrodes are then further washed in water to remove the excess alkali metal, and then dried to prepare them for integration into a capacitor.

Two such electrodes are bonded to aluminum collectors, and with a microporous polypropylene separator interposed between them, and placed in a polymer foil pouch. The pouch is vacuum-filled with 2.7 molar 1-methyl-3-ethylammonium tetrafluoroborate in propylene carbonate, and sealed leaving two aluminum tabs, one connected to each electrode, exposed through the seal. The capacitor is then cycled 5 times to complete the “electrochemical activation” of the electrodes.

The present invention provides a capacitor having a high volumetric capacity and wide potential range, while eliminating the expansion problems caused by typical binding methods using graphitic carbons. The present invention achieves volumetric densities of 25-45 F/cc at voltages above 3.5 volts.

One of skill in the art will appreciate that the electric double layer capacitor, the method for producing the same, and the method for creating storage moderated energy generation systems according to the present invention are not limited to the embodiments described above, which may be embodied in other various forms without deviating from the spirit and intent of the present invention.

1. A method for producing a double-layer capacitor electrode, the method comprising:
providing a carbonaceous material formed into a electrode pre-form;
providing an alkali containing compound; and
heating the electrode pre-form together with the alkali containing compound in a substantially anoxic environment.

2. The method of claim 1, wherein the carbonaceous material is derived from a carbon bearing pre-cursor heated in a substantially anoxic environment.

3. The method of claim 1, wherein the carbonaceous material is a carbon bearing precursor and wherein the carbonaceous material is carbonized or graphitized and alkali processed in the single heat cycle within the substantially anoxic environment.

4. The method of claim 2, wherein the carbon bearing precursor comprises a substance selected from the group consisting of coal, oil, petroleum, coke, pitch, lignite, high molecular weight oils, high molecular weight waxes, or asphaltenes.

5. The method of claim 4, wherein the carbon bearing pre-cursor is heated to a temperature of greater than 700° C. and less than 1300° C.

6. The method of claim 1, wherein the carbon bearing precursor comprises a herbaceous material.

7. The method of claim 6, wherein the herbaceous material is selected from the group consisting of wood, bamboo, cellulose, hemicellulose, lignins, coconut husks, nut shells, peat, fruit pits, corn stalks, and grain husks.

8. The method of claim 2, wherein the carbon bearing precursor is a sugar, polysaccharide or starch.

9. The method of claim 6, wherein the carbon bearing precursor is heated to a temperature that is greater than 1400° C. and less than 1900° C.

10. The method of claim 2, wherein binding the carbonaceous material comprises utilizing a bonding agent comprising at least one carbon bearing substance.

11. The method of claim 10, wherein the bonding agent forms a primarily amorphous or glassy carbon in response to heating.

12. The method of claim 10, wherein the bonding agent comprises a thermoset resin.

13. The method of claim 12, wherein the thermoset resin is selected from the group consisting of phenolic resins, furfural resins, and epoxide resins.

14. The method of claim 10, wherein the bonding agent comprises a thermoplastic polymer.

15. The method of claim 14, wherein the thermoplastic polymer is selected from the group consisting of methyl cellulose, polyvinylidene difluoride, polyethylene, polypropylene, and polylactic acid.

16. The method of claim 10, wherein bonding agent is selected from the group consisting of wood, coal, petroleum tar, asphaltene, bitumen, high molecular weight hydrocarbons, hemicellulose, lignin, cellulose, starch, and protein.

17. The method of claim 1, wherein the alkali compound comprises a substance selected from the group consisting of metallic potassium, potassium hydroxide, potassium carbonate, potassium acetate, potassium benzoate, potassium butyrate, potassium formate, potassium peroxide; metallic sodium, sodium hydroxide, sodium carbonate, sodium acetate, sodium benzoate, sodium butyrate, sodium formate, and sodium peroxide.

18. The method of claim 1, wherein the pre-formed electrode is heated to a temperature sufficient to produce alkali metal vapor.

19. The method of claim 1, further holding the capacitor cell electrode within a rigid container during a charging cycle, whereby containing expansion of the electrode material.

20. A double layer capacitor cell comprising:
a plurality of polarizable electrodes produced according to the method of claim 1; and
an electrolyte in electrolytic communication with the electrodes.

21. A capacitor cell comprising:
a polarizable electrode produced according to the method of claim 1; and
an electrolyte in electrolytic communication with the electrode.
